(19) United States
(12) Patent Application Publication
(10) Pub. No.: US 2010/0023936 A1
(43) Pub. Date: Jan. 28, 2010

(54) PROGRAM MODIFICATION METHOD, PROGRAM RESTORATION METHOD AND DATA PROCESSING DEVICE

(75) Inventor: Masaki FUJITA, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 12/492,791

(22) Filed: Jun. 26, 2009

(30) Foreign Application Priority Data
Jul. 28, 2008 (JP) 2008-193664

(51) Int. Cl. G06F 9/44

(52) U.S. Cl. 717/168; 717/170

(57) ABSTRACT

One system to which the present invention is applied collects real data to be used to modify a program modification data having the identification data of the real data for each program to be modified, of a group of programs to be managed and regularly modified, makes a person in charge select desired modification data from the collected modification data, using the identification data of the collected modification data and makes the person in charge modify a program corresponding to the modification data, using the selected modification data.

### CROSS-REFERENCE TO RELATED APPLICATION

This application is based upon and claims the benefit of priority of the prior Japanese Patent Application No. 2008-193664 filed on Jul. 28, 2008, the entire contents of which are incorporated herein by reference.

### FIELD

The embodiments discussed herein are related to a technology for revising a program to be modified, of a group of programs to be regularly modified.

### BACKGROUND

Sometimes a plurality of programs (software) is sold together. For example, as to business application program (hereinafter omitted as “application”), sometimes in addition to an application for supporting target business, an application desired to operate the application or an application for improving the serviceability are sold together.

Today, functions to support have increased and there is a tendency that the scale of an application increases remarkably. Thus, in the development of an application it is very difficult to completely eliminate all bugs. Sometimes it becomes preferable to add a new function. Therefore, an application is often modified after sale.

It is common to regularly modify program, such as an application and like, except an emergency modification requiring high urgency and individual modification. In the case of regularly conducted modification (regular modification), conventionally data to modify program to be modified is collected and all programs corresponding to the collected data are modified. It is common that such a regular modification is made by the seller of such a program or the maker (program manufacturer).

Since the modification of programs presumes the use of all of the modification data, for the modification data collected for each regular modification, only data used to modify a corresponding program (real data) is collected. Therefore, it is difficult for a person in charge of an actual regular modification to find the programs to be actually modified in the regular modification. Specifically, in order to check a program to be actually modified in the regular modification, it is preferable to check the collected data.

Sometimes a customer whose programs are desired to be regularly modified desires to minimize the number of programs to be modified for fear of level-down caused by the regular modification. Not a few customers desire to modify only programs whose modification is considered preferable. Taking this into consideration, it is also important to be able to modify only programs whose modification is considered preferable, in a regular modification.

The modified program can be backed out for restoring to before modification. However, since all pieces of modification data collected for a regular modification are used to modify programs, conventionally back-out is performed for each regular modification. Therefore, it is impossible to modify only a program desired to modify.

Patent document 1: Japanese Laid-open Patent Publication No. H7-175643

Patent document 2: Japanese Laid-open Patent Publication No. 2001-5647

### SUMMARY

According to an aspect of the invention, one system collects real data to be used to modify a program and modification data having the identification data of the real data for each program to be modified in a group of programs to be managed and regularly modified, enables a person in charge to select preferable modification data from the collected modification data, using the identification data of the modification data and enables the person in charge to modify programs corresponding to the modification data, using the selected modification data.

Identification data provides a person in charge with the more detailed information of real data. When making a person in charge to select modification data using the identification data, the person in charge can easily select only a program to be modified according to information possessed by the identification data.

The object and advantages of the invention may be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 explains the procedure of making a regular modification, realized by this preferred embodiment;

FIG. 2 is a data structure of program modification 1;

FIG. 3 is a system configuration of a modification management server 10;

FIGS. 4A-4C are structures of regular modification data;

FIGS. 5A&5B are example data structures of program modification 1;

FIGS. 6A-6C illustrate the example contents of a corresponding table generated for each regular modification;

FIG. 7 is the first example of a regular modification description-oriented selection screen;

FIG. 8 is the first example of a detail-oriented selection screen;

FIG. 9 is the second example of a regular modification description-oriented selection screen;

FIG. 10 is the second example of a detail-oriented selection screen;

FIG. 11 is a configuration of a modification application system 20;

FIGS. 12A-12C explain a program saved by the application of a modification;

FIG. 13 is the first example of a regular modification description-oriented modification history check screen;

FIG. 14 is the second example of a regular modification description-oriented modification history check screen; and

FIG. 15 illustrates one example of the preferred embodiment of hardware configuration.

### DESCRIPTION OF EMBODIMENTS

One example of the preferred embodiments of the present invention will be explained in detail with reference to accompanying drawings.

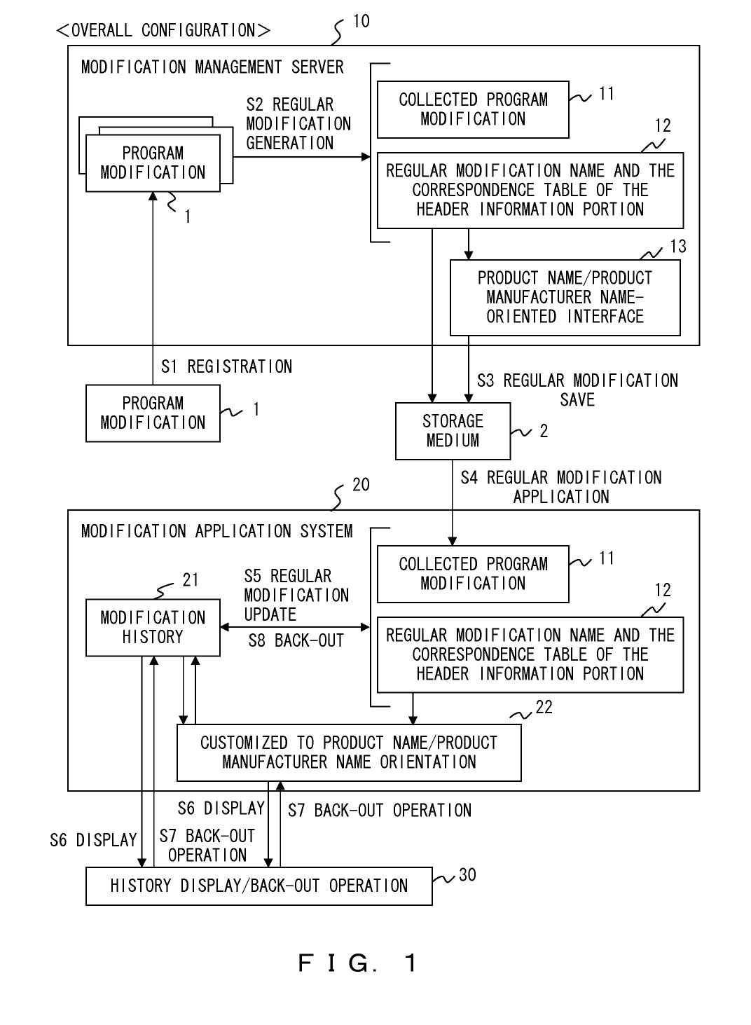

FIG. 1 explains the procedure of making a regular modification, realized by this preferred embodiment. The procedure is a procedure in the case where the data processing device 20 on the customer side does the regular modification of an application managed by it, using a modification management server 10 being a data processing device for managing modification data 1 for modifying an application. In FIG. 1, the modification data 1 is described as “program modification”. “Modification application system” is a program installed for application modification in a data processing device 20 for managing an application to be modified. Since the application modification in the data processing device 20 is made by the modification application system, hereinafter a reference numeral 20 is also attached to the modification application system. The modification data is hereinafter described as “Program modification”.

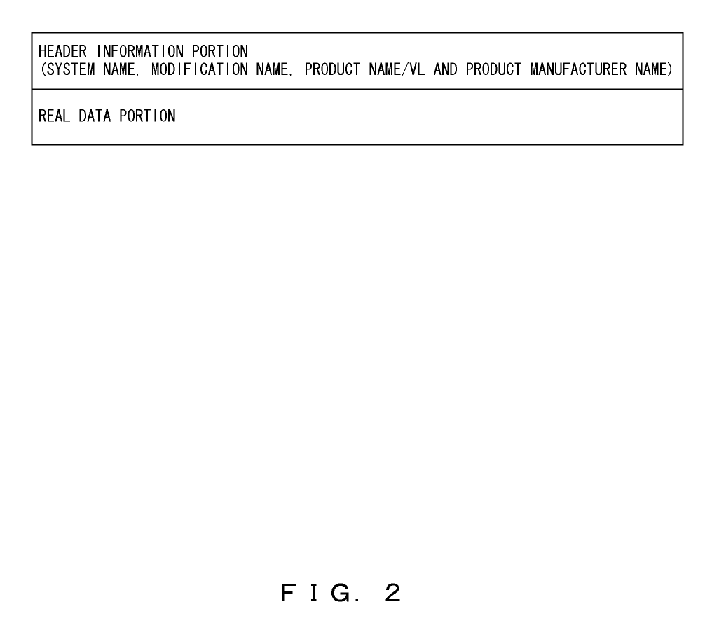

FIG. 2 is a data structure of the program modification 1. As illustrated in FIG. 2, the program modification 1 includes a header information portion and a real data portion. The real data portion stores data to be actually used to modify a corresponding application (real data) and the header information portion stores the identification data of the real data portion. In this preferred embodiment, as the identification data, respective data of system name, modification number, product name/VL (version level) and product manufacturer name are stored.

The system name is the title of a system in which an application to be modified by the real data portion operates and, for example, the application is sold together for configuring the system. The modification number is identification data capable of uniquely specifying data stored in the real data portion. The product name/VL indicates the product description of an application (including a version level, as necessary). The product manufacturer name indicates a company (maker) that has developed the application. How the program modification 1 modifies which application can be easily known. Hereinafter various pieces of data stored in the header information portion are generally called “header information”.

The types of data stored in the header information portion can also be combinations other than the above. However, it is preferable to include at least an application to be modified and a modification number for making the specification of the modification contents easy.

In this preferred embodiment, the following regular modifications are possible using the program modification 1 having the data structure illustrated in FIG. 2, which will be explained in detail with reference to FIG. 1.

The program modification 1 generated for a regular modification by a product manufacturer or the like is registered in the modification management server 10 (Sequence S1). Thus, the program modification 1 is collected on the modification management server 10 for a regular modification (Sequence S2). The collected program modification 11 is hereinafter called “collection program modification”.

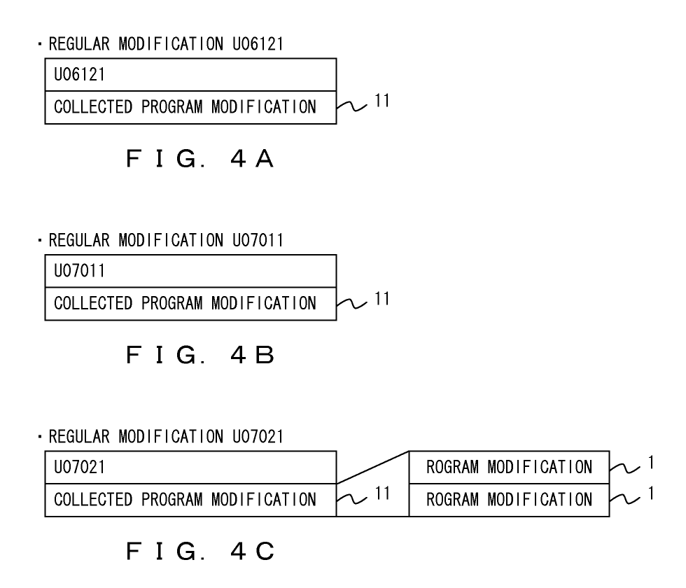

To the collection program modification 11, data uniquely indicating a corresponding regular modification is added. The data uniquely indicating a corresponding regular modification is called “regular modification name”. The collection program modification 11 to which the regular modification name is attached has data structures as illustrated in FIGS. 4A through 4C. The collection program modification 11 to which the regular modification name is attached is hereinafter called “regular modification data”.

For a regular modification, besides the collection program modification 11, a correspondence table 12 which defines correspondence between the regular modification and the header information portion of each program modification 1 is generated (Sequence S2). The collection program modification 11 and the correspondence table 12 are generated by the modification management server 20 according to the instruction of an operator.

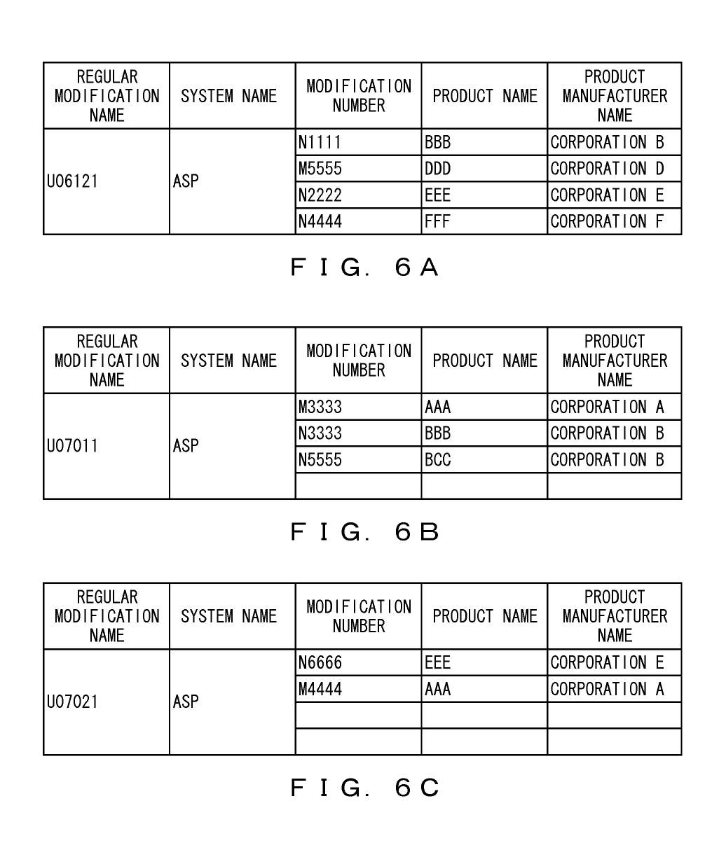

The contents of the correspondence table 12 are, for example, as illustrated in FIGS. 6A through 6C. The correspondence tables 12 whose contents are illustrated in FIGS. 6A through 6C correspond to the regular modification data whose structures are illustrated in FIGS. 4A through 4C, respectively. In the regular modification data whose structure is illustrated in FIG. 4C, the collection program modification 11 is composed of two program modifications 1 in the header information portion of which are stored respective pieces of data illustrated in FIG. 6C.

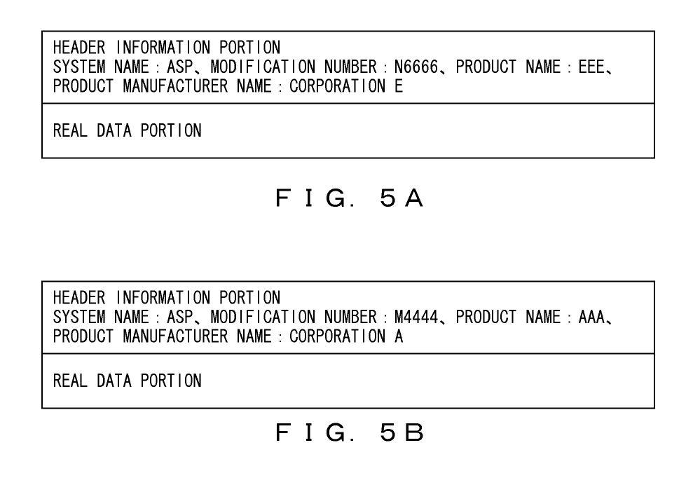

Each of FIGS. 5A and 5B illustrates the data structure of the program modification 1 of a regular modification data to which “U07021” is attached as a regular modification name. The program modification 1 whose data structure is illustrated in FIG. 5A stores in the header information portion data “ASP”, “N6666”, “EEE” and “corporation E” as the system name, modification number, product name and product manufacturer name, respectively. The program modification 1 whose data structure is illustrated in FIG. 5B stores in the header information portion data “ASP”, “m4444”, “AAA” and “corporation A” as the system name, modification number, product name and product manufacturer name, respectively.

For the regular modification whose regular modification name is known, a notation in which a regular modification name follows after the “regular modification” is hereinafter used. Thus, the regular modification whose regular modification data is illustrated in FIG. 4C is expressed as a “regular modification 07021”. Similarly, when expressing regular modification data whose regular modification name is known, a notation in which a regular modification name follows after the “regular modification data” is used. Thus, the regular modification data illustrated in FIG. 4C is expressed as “regular modification data U07021”.

A person in charge of a regular modification on the customer side (a regular modification user) saves (copies) the regular modification data in, for example, a storage medium 2 together with the correspondence table 12 (sequence S3). This is saved using an interface 13 realized by a program installed by the modification management server 10. By this interface, only a selected program modification 1, of the collection program modification 11 of the regular modification data is saved in the storage medium 2.

The regular modification data and the correspondence table 12 that are saved (copied) in the storage medium 2 are applied to the modification application system 20 by the regular modification user (Sequence S4). By the application, the modification application system 20 modifies a corresponding application, using the program modification 1 included in the regular modification data. After the modification, the modification application system 20 updates a modification history 21 (Sequence S5).

A reference numeral 30 in FIG. 1 is a personal computer (hereinafter called “PC”) connected to a terminal device accessible to the modification application system 20, such as a data processing device in which the modification application system 20 operates, via a cable or communication network. The user of the PC 30 is a regular modification user. When the user operates the PC 30 to request for history display, the modification application system 20 reads the modification history 21, generates display data, for example, HTML data and transmits the data to the PC 30 (Sequence S6). As to the HTML data, the user can select it from regular modification name-oriented data whose regular modification name can be checked and product name/product manufacturer name-oriented data whose product name/product manufacturer name can be checked. Hereinafter, the former and the latter are called “regular modification name-oriented data” and “detail-oriented data”, respectively.

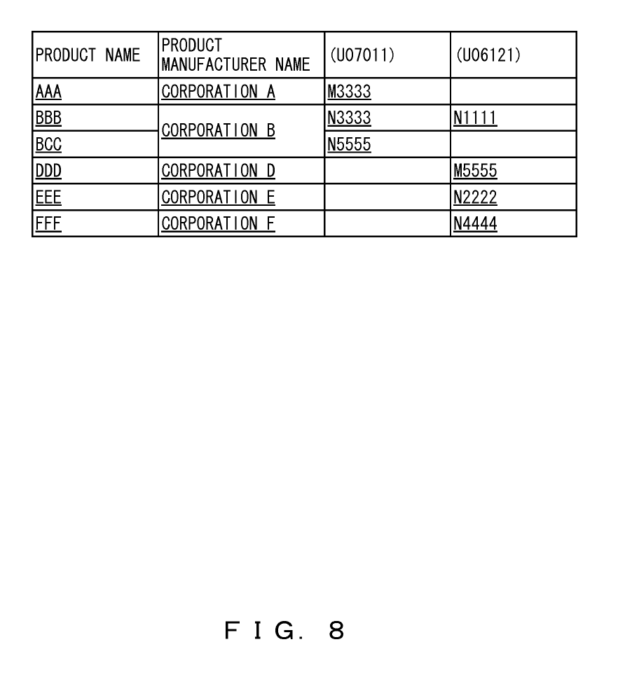

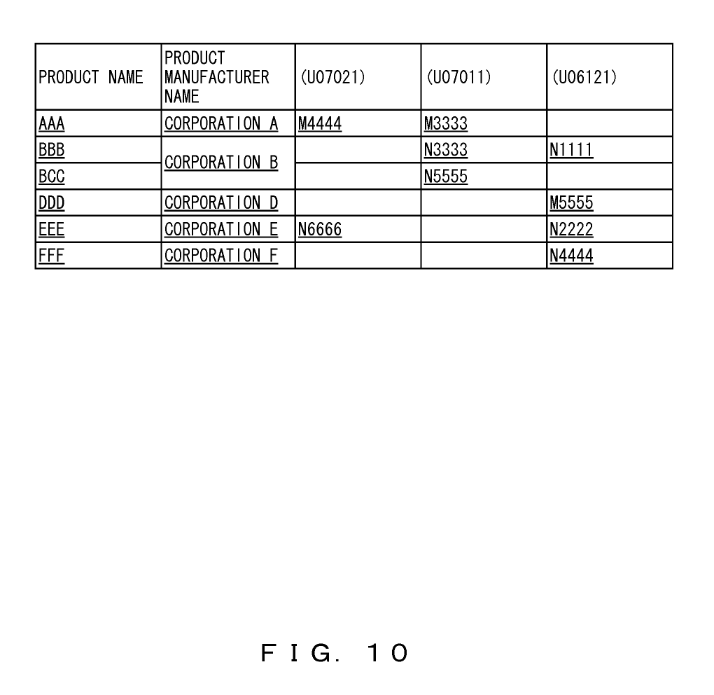

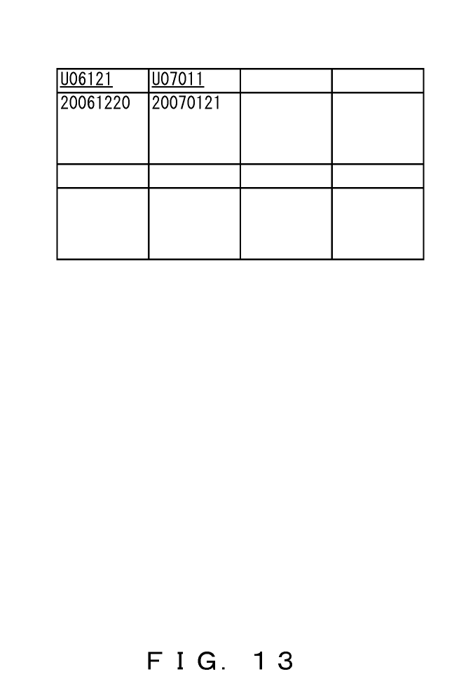

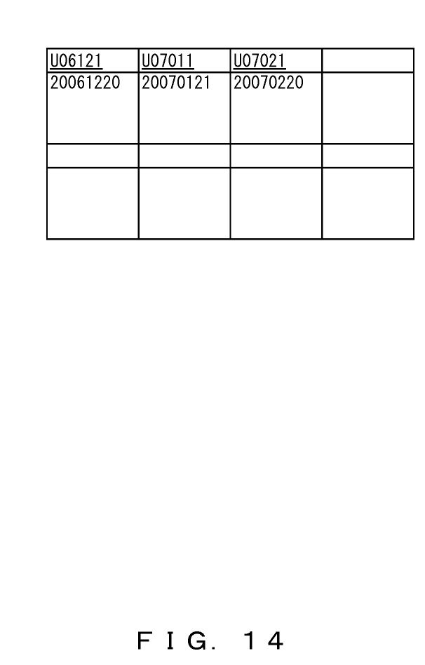

For example, when modifying an application using two pieces of regular modification data illustrated FIGS. 4A and 4B, as illustrated in FIG. 13, the regular modification name-oriented data displays a check screen on which a modification history can be checked for each regular modification. The detail-oriented data displays a check screen on which a modification history can be checked for each program modification 1 and for each regular modification, as illustrated in FIG. 8. Furthermore, when a modification is made using the regular modification data illustrated in FIG. 4C, the regular modification name-oriented data is changed to display a modification history, as illustrated in FIG. 14 since the modification history 21 is updated by the modification. The detail-oriented data is changed to display a modification history, as illustrated in FIG. 10.

In FIGS. 8, 10, 13 and 14, an underlined character string is an operable button. To each button, a function to instruct the execution of back-out indicated by the character string is assigned. Thus, in the regular modification name-oriented data, for example, a button whose character string is “U07011” indicating a regular modification name can instruct the execution of back-out for each regular modification (FIGS. 13 and 14). In the detail-oriented data, for example, a button whose character string is “N3333” can back out in such a way as not to apply a modification by the program modification 1 whose modification number is N3333 to an application whose product name modified by a regular modification whose regular modification name is “U07011” is “BBB” and whose product manufacturer name is “corporation B”. A button whose character string is “corporation B” can back out in such a way as not to apply all modifications to any of two applications whose product names provided by corporation B are “BBB” and “BCC” (FIGS. 8 and 10). In this way, the detail-oriented data can arbitrarily back out only an application desired by the user in a desired state.

Thus, by clicking any button, back-out can be operated (Sequence S7). When the back-out operation is executed, the modification application system 20 executes the back-out instructed by the operation and updates the modification history 21 (Sequence S8).

A reference numeral 22 in FIG. 1 is a group of programs for generating detail-oriented data from the modification history 21 and executing back-out according to an operation made on a screen displayed by the detail-oriented data. In this preferred embodiment, by incorporating the program group 22 into the modification application system 20, desired back-out can be executed for each application and for each program modification 1 (including for each regular modification).

When a modification history is displayed as illustrated in FIGS. 8 and 10, the user (the person in charge) can easily know which modification has been applied to which application (product) in which regular modification. Therefore, the back-out of which modification may be applied to which application and the like can also be easily specified. For example, when some bug occurs after a regular modification, the modification of an application that is doubted as the cause of the occurrence of the bug can be easily specified. A program modification 1 having a bug can also be easily specified. Not only the cause of a bug can be specified, but the specified cause can be also solved. This is because a modification can be applied to only an application to be modified by back-out even after a modification. Thus, high serviceability can be realized.

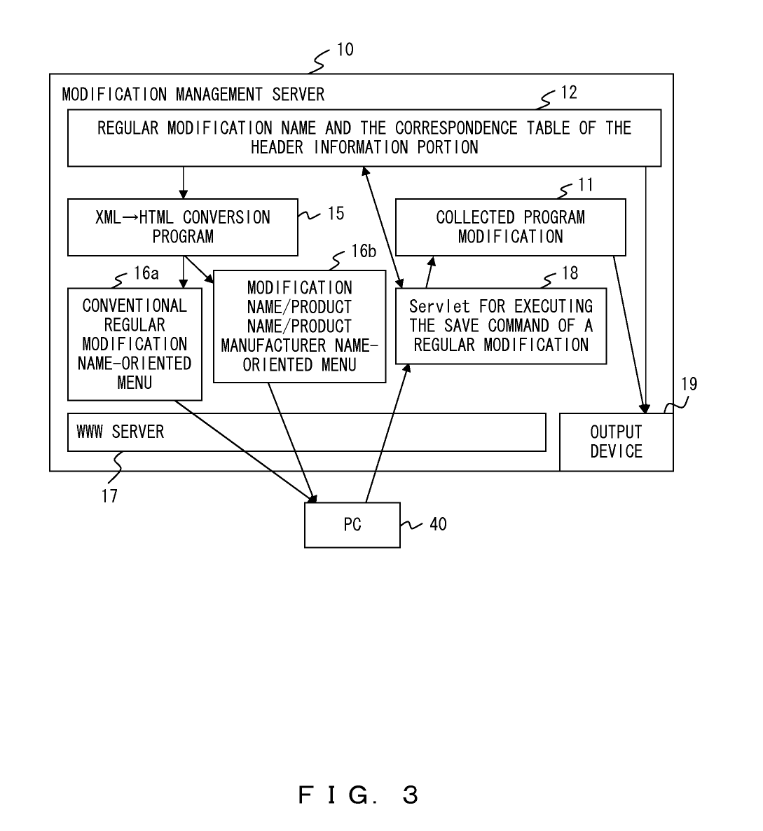

FIG. 3 is a system configuration of the modification management server 10. Next, the modification management server 10 will be explained in more detail with reference to FIG. 3.

The modification management server 10 is connected to a PC 4 being a terminal device via a communication network, such as a LAN or the like. Thus, a generated program modification 1 is usually registered in the modification management server 10 via the PC 40. In order to enable such registration, a WWW server 17 being software for realizing data transmission with the PC 40 is installed in the modification management server 10.

The correspondence table 12 generates XML data in order to make it non-OS (operating system)-dependent. A conversion program 15 generates HTML data for a selection screen display for enabling a person in charge to select a regular modification data using the correspondence table 12 of XML data. As to the HTML data, as in the case of displaying a modification history, the person in charge can select it from regular modification name-oriented data whose regular modification name can be checked and product name/product manufacturer name-oriented data whose product name/product manufacturer name can be checked. Hereinafter, as in the case with a modification history, the former and the latter are called “regular modification name-oriented data” and “detail-oriented data”, respectively. A reference numeral 16a in FIG. 3 is regular modification name-oriented data and is expressed as a “conventional regular modification name-oriented menu” in FIG. 3. A reference numeral 16b in FIG. 3 is detail-oriented data and is expressed as a “modification number/product name/product manufacture name-oriented menu” in FIG. 3.

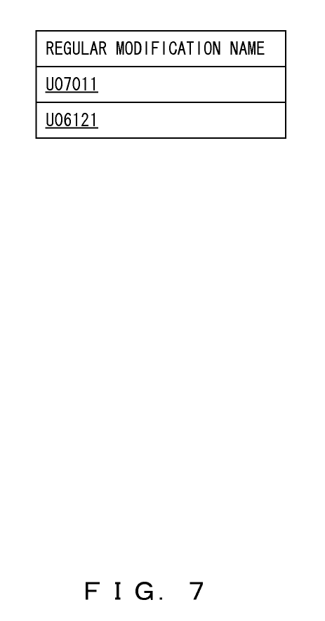

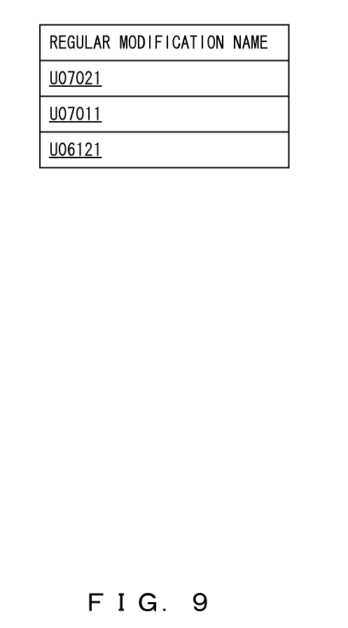

For example, when the two pieces of regular modification data illustrated in FIGS. 4A and 4B exist in the modification application server 10, as illustrated in FIG. 7, the regular modification name-oriented data 16a displays a selection screen on which a regular modification name in which the collection program modification 11 exists is disposed. The detail-oriented data 16b displays a selection screen which presents selectable program modifications 1 for each regular modification, as illustrated in FIG. 8. Furthermore, when the new regular modification data illustrated in FIG. 4C is generated, by the generation the regular modification name-oriented data 16a is changed to display a regular modification name, as illustrated in FIG. 9. The detail-oriented data 16b is changed to present selectable program modifications 1, as illustrated in FIG. 10.

In FIGS. 7 and 9 too, each underlined character string is an operable button. To each button, a function to instruct the save (copy) of the program modification 1 indicated by the character string is assigned. Thus, in the regular modification name-oriented data 16a, for example, a button whose character string is “U07011” indicating a regular modification name can instruct the save of all pieces of regular modification data U07011 (FIGS. 7 and 9). In the detail-oriented data 16b, for example, a button whose character string is “N3333” can instruct the save of only program modification 1 whose modification number is “N3333”. That is, in the regular modification whose regular modification name is “U07011”, the button can instruct the save of only program modification 1 for modifying the application whose product name is “BBB”. A button whose character string is “corporation B” can instruct the save of all program modifications 1 used for the modification of any of two applications whose product names provided by corporation B are “BBB” and “BCC” (FIGS. 8 and 10).

The contents of an operation made on a screen having an image illustrated in any of FIGS. 7 through 10 are reported from the PC 40 as a command to be executed by the modification management server 10. By the notice, only the program modification 1 specified by the operation of the person in charge is saved in the storage medium 2 by an output device 19 as regular modification data, together with the correspondence table 12 of the regular modification data. The output device 19 is, for example, an optical disk device.

The command transmitted from the PC 40 is transferred to a Servlet 18 via the WWW (World Wide Web) server 17. The Servlet 18 analyzes the command, specifies the contents of a process to be performed and performs the process of the contents. The analysis of the command is made referring to, for example, the correspondence table 12. In this case, the person in charge operates the PC 40 to specify the instructed contents and perform a process according to the instruction. As a result, only a program modification 1 desired by the person in charge of operating the PC 40 is saved in the storage medium 2. Thus, the interface 13 illustrated I FIG. 1 is realized by the conversion program 15 and the Servlet 18. It is because the Servlet 18 is non-OS-dependent that the Servlet 18 is used to save the program modification 1 in the storage medium 2.

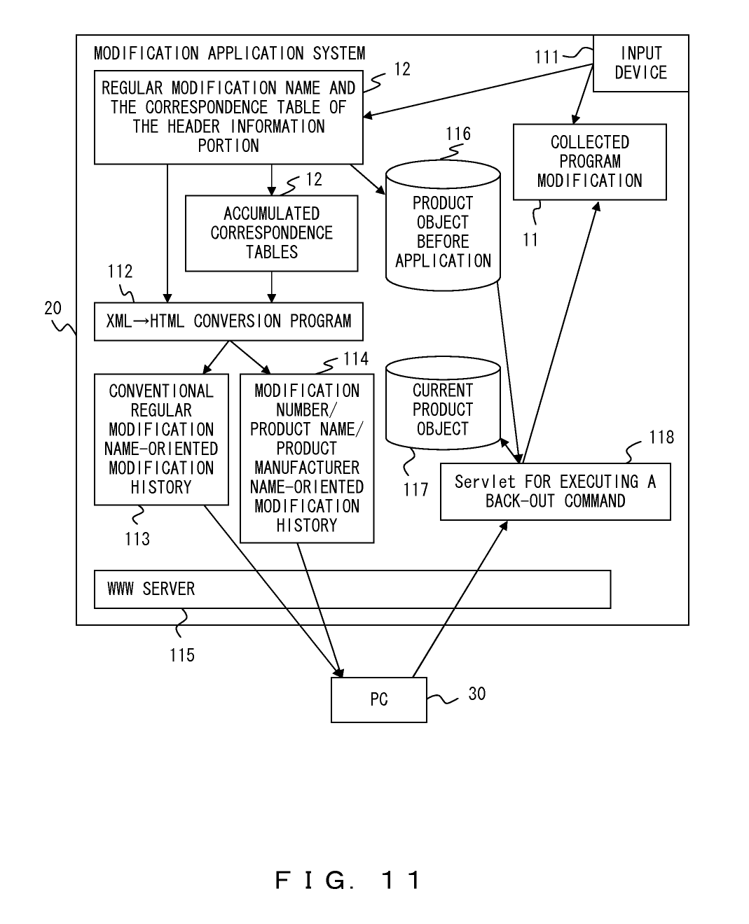

FIG. 11 is a configuration of the modification application system 20. Next, the modification application system 20 will be explained in more detail with reference to FIG. 11.

Since this preferred embodiment presumes the save (copy) of regular modification data in the storage medium 2, the data processing device 20 operated by the modification application system 20 includes an input device 111 accessible to the storage medium 2. The regular modification data and the correspondence table 12 that are stored in the storage medium 2 are taken in the modification application system 20 via the input device 111. In the modification application system 20, a WWW server 115 being software for realizing the data transmission with the PC 30 is installed.

In the storage medium 2, the program modification 1 to be modified is selected and stored. Thus, the modification application system 20 modifies all programs corresponding to all program modifications 1 stored in the storage medium 2. Prior to the modification, all programs to be modified are saved. Thus, after modification, arbitrary back-out becomes possible. A reference numeral 116 in FIG. 11 is a program before the application of a modification. In FIG. 11, the program is expressed as a “product object before application”.

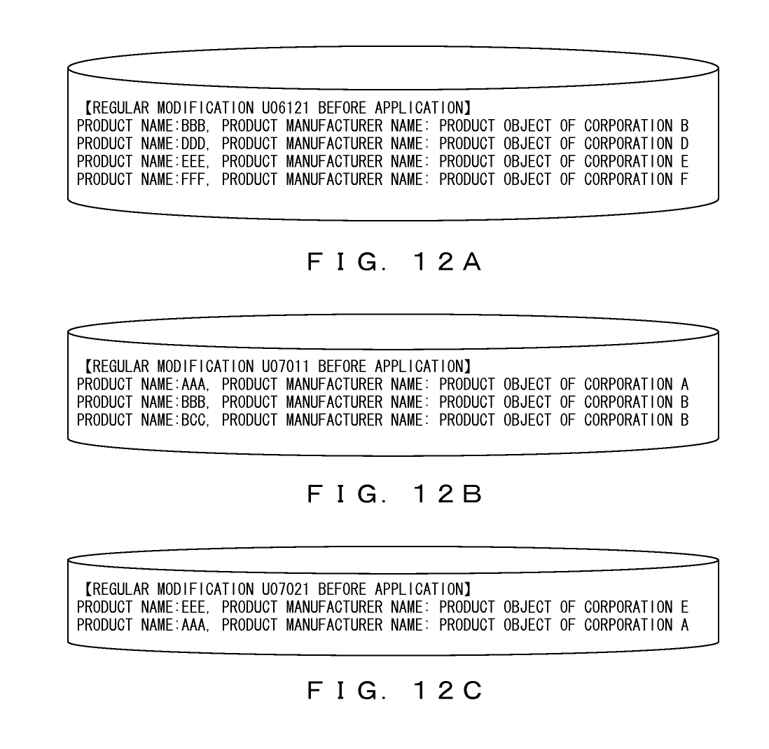

FIGS. 12A-12C explain a program saved by the application of a modification. FIGS. 12A through 12C indicate a program to be saved when the correspondence table 12 whose contents are indicated in FIGS. 6A through 6C, respectively are taken in. As illustrated in FIGS. 12A through 12C, all programs to be modified are saved. This save is performed by storing a program before application in a hard disk device or the like.

The correspondence tables 12 previously taken in are stored so as to back out the program modification. The correspondence table 12 immediately after being taken in indicates a modification (modification history) made by a regular modification data taken in together with the correspondence table 12. Thus, the stored correspondence table 12 is used as the modification history 21 in FIG. 1. Therefore, when backing out the program modification, the correspondence table 12 indicating the program modification 1 is updated according to the program modification 1 to which a modification is not applied due to the back-out. Back-out and the update of the correspondence table 12 following the back-out are made by the Servlet 118.

The conversion program 112 generates regular modification name-oriented data 113 or detail-oriented data 114, using the correspondence table 12 including a newly taken correspondence table 12. The data is generated by the modification application system 20 according to an instruction from the PC 30. The generated regular modification name-oriented data 113 or detail-oriented data 114 are transmitted to the PC 30 via the WWW server 115. As a result, the PC 30 displays a screen illustrated in FIG. 13, 14, 8 or 10. By such screen display, the person in charge can execute back-out in such a way as to check a modification history and not to apply an unnecessary program modification. In FIG. 11, the regular modification name-oriented data 113 and the detail-oriented data 114 are expressed as a “conventional regular modification name-oriented modification history” and a “modification number/product name/product manufacturer name-oriented modification history”, respectively.

The contents of an operation made on a screen illustrated in FIG. 13, 14, 8 or 10, by the person in charge using the PC 30, that is, a command is transferred to the Servlet 118 via the WWW server 115. The Servlet 118 analyzes the command referring to, for example, the correspondence table 12 and performs the process instructed by the person in charge. If the process is back-out, the Servlet 118 saves a program 117 before back-out, that is, a program 117 after modification application. This is made so that the program 117 can be restored to a state before back-out. In FIG. 11, this program 117 is expressed as a “current product object”.

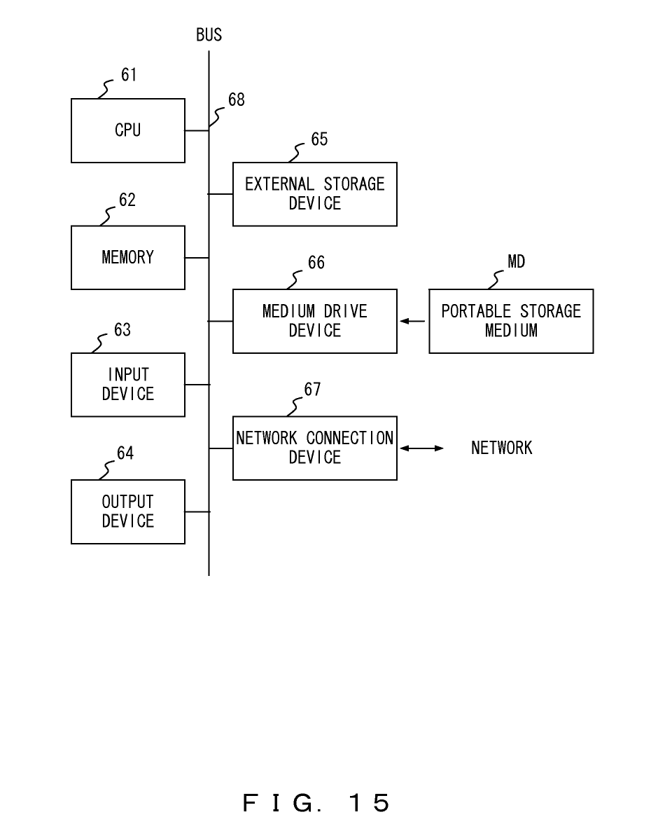

FIG. 15 illustrates one example of the hardware configuration of a computer as the preferred embodiment. Next, the configuration of a computer applicable as the modification management server 10 will be specifically explained with reference to FIG. 15.

A computer illustrated in FIG. 15 includes a CPU 61, memory 62, an input device 63, an output device 64, an external storage device 65, a medium drive device 66 and a network connection device 67, which are connected to each other by a bus 68. The configuration illustrated in FIG. 15 is one example and is not restrictive of the invention.

The CPU 61 controls the entire computer.

The memory 62 is RAM or the like for temporarily storing a program or data stored in the external storage device 65 (or a portable storage medium MD) when executing the program, updating the data and the like. The CPU 61 controls the entire computer by reading the program into the memory 62 and executing the program.

The input device 63 is an interface connected to an operation device, such as a keyboard, mouse or the like. The input device 63 detects the operation on the operation device of a user and notifies the CPU 61 of the detection result.

The output device 64 is, for example, a display control device connected to a display device. The network connection device 67 is used to communicate with an external device via a communication network, such as an intranet, the Internet or the like. The external storage device 65 is, for example, a hard disk device. The external storage device 65 is mainly used to store various types of data and programs.

The medium drive device 66 is used to access a portable storage medium MD, such as an optical disk, a magneto-optical disk or the like. The medium drive device 66 can be used as the output device 19 illustrated in FIG. 3. When using r the medium drive device 66 as the output device 19, the storage medium 2 is a storage medium MD that can be accessed by the medium drive device 66.

The collection program modification 11, the correspondence table 12, the WWW server 17, the conversion program 15 and the Servlet 18 that are illustrated in FIG. 3 are all stored in, for example, the memory 62 or the external storage device 65.

The computer whose configuration is illustrated in FIG. 15 can be used as the data processing device 20 for operating the modification application system 20. When the computer is used as the data processing device 20, the input device illustrated in FIG. 11 can be used as the medium drive device 66. A group of applications (programs) to be regularly modified is stored in an accessible storage device via, for example, the external storage device 65 or the network connection device 67. The program 116 or 117 for saving data by modification or back-out is also stored in an accessible storage device via, for example, the external storage device 65 or the network connection device 67.

As described above, one system to which this preferred embodiment is applied collects real data used to modify a program and modification data having the identification data of the real data, for each program to be modified, of a group of programs to be managed and regularly modified, makes a person in charge select desired modification data from the collected modification data and makes the person in charge modify a program corresponding to the modification data, using the selected modification data.

The identification data provides the person in charge the more detailed information of the real data. When making the person in charge to select desired modification data using the identification data, the person in charge can easily select only a program to be modified, according to the information of the identification data. As a result, even when there are many programs to be regularly modified and also many programs are actually modified, only a program to be modified of them can be easily modified. The modification of only a program to be modified can be realized by selecting a program for not applying the modification to it after modifying it. Thus, even if any method is used, a program to be modified this time, of programs to be regularly modified can be easily modified.

Although in this preferred embodiment, only a desired program modification 1 is outputted from the modification management server 10 for registering/managing the program modifications 1, this is made so that the number of functions added to the data processing device (for example, a server) 20 on the customer side that manages applications to be regularly modified (sometimes including another data processing device connectable to the data processing device 20) can be suppressed to a minimum. If there is no need to take such a thing into consideration, all program modifications 1 constituting the collection program modification 11 can also be unconditionally saved in the storage medium 2 and the customer side can also select a program modification to be actually used.

1. A program modification method for modifying a program to be modified in a group of programs to be managed and regularly modified by a data processing device, comprising:
collecting real data used to modify the program for each program to be modified and modification data having identification data of the real data; and
making a person in charge to select modification data from the collected modification data, using identification data of the collected modification data and making the data processing device to modify a program corresponding to the modification data using the selected modification data.

2. The program modification method according to claim 1, wherein
the collected modification data is presented using the identification data of the modification data, a selection screen on which modification data used for the regular modification can be selected from the presented modification data for each of the modification data and a person in charge selects the modification data.

3. The program modification method according to claim 2, wherein
the modification data used for the regular modification can be selected for each of the regular modification.

4. The program modification method according to claim 2, wherein
the modification data is also selected for each of the regular modification in another selection process, and
a person in charge selects one of the two selection processes.

5. The program modification method according to claim 2, wherein
the modification data is collected by another data processing device and
the another data processing device outputs modification data, of the modification data collected by the other data processing device.

6. The program modification method according to claim 1, further comprising
restoration process making a person in charge select modification data used to modify the program and restoring the program modified by the selected modification data to a state before the modification.

7. The program modification method according to claim 6, wherein
a person in charge select the modification data used to modify the program to be restored to a state before the modification, using the identification data of the modification data.

8. The program modification method according to claim 1, wherein
the identification data indicates at least one of a name of a system in which a program to be modified by the real data, a modification number capable of uniquely specifying the real data, a product name of the program and a name of a product manufacturer that has developed the program.

9. A program restoration method for restoring a modified program in a group of programs to be managed and regularly modified by a data processing device to a state before modification, comprising:
obtaining real data used to modify the program and modification data having identification data of the real data for each modified program, of the group of programs; and
making a person in charge select modification data used to modify a program to be restored to a state before the modification, using the identification data of modification data obtained in the acquisition process and restoring a program modified using the selected modification data to a state before the modification.

10. The program restoration method according to claim 9, wherein
the modification data used to modify the program is presented using the identification data of the modification data, a selection screen on which modification data used to modify a program to be restored to a state before the modification can be selected from the presented modification data for each of the modification data is generated and the modification program is selected.

11. A data processing device for managing modification data used to modify a program to be modified in a group of programs to be regularly modified, comprising:
a collection unit capable of collecting real data used to modify the program and modification data having identification data of the real data as the modification data for each of the program to be modified;
a selection unit capable of making a person in charge select necessary modification data from the collected modification data using identification data of modification data collected by the collection unit; and
an output unit capable of outputting modification data selected by the selection unit.

12. A data processing device for managing a group of programs to be regularly modified, comprising:
an acquisition unit capable of obtaining real data used to modify the program and modification data having identification data of the real data for each modified program, of the group of programs;
a modification unit capable of modifying a corresponding program, using modification data obtained by the acquisition unit;
a selection unit capable of making a person in charge select modification data used to modify a program to be restored to a state before modification, of programs modified by the modification unit, using identification data of modification data obtained by the acquisition unit; and
a restoration unit capable of restoring a program modified by modification data selected by the selection unit.
